(19) United States
(12) Patent Application Publication
(10) Pub. No.: US 2013/0119944 A1
(43) Pub. Date: May 16, 2013

(54) TRANSMISSION OF DATA RELATING TO THE OPERATION OF A BATTERY POWERING A DRIVING MOTOR OF A MOTOR VEHICLE

(71) Applicant: Jean-Yves Stineau, Montigny Le Bretonneux (FR)

(72) Inventor: Jean-Yves Stineau, Montigny Le Bretonneux (FR)

(73) Assignee: RENAULT S.A.S., Boulogne-Billancourt (FR)

(21) Appl. No.: 13/807,996

(22) PCT Filed: Jun. 28, 2011
(86) PCT No.: PCT/FR2011/051494

§ 371 Date: Jan. 31, 2013

(30) Foreign Application Priority Data
Jul. 2, 2010 (FR) 1055351
Jul. 2, 2010 (FR) 1055352

(51) Int. Cl. B60L 11/18

(52) U.S. Cl. CPC B60L 11/1861; B60L 11/1809
USPC 320/137; 701/1

(57) ABSTRACT

A method for managing a battery used to drive a motor vehicle. The method includes: storing data relating to the battery, as a function of time, during certain use phases of the motor vehicle; and transmitting battery-related data stored in a memory unit of a central server during a charging phase of the battery in a battery management station.

The present invention relates to a method and device for managing an energy container of the battery type on an electric motor vehicle. Hereinafter the term battery will be used for the purposes of simplification.

Certain motor vehicles, such as electric or hybrid vehicles, comprise a battery for powering an electric driving motor. The drawback of this solution stems from the short range of such a battery which requires it to be regularly recharged or replaced.

The object of the invention is to provide a solution for improving the performance of a battery of a motor vehicle.

Accordingly, the invention is based on a method for managing a battery for driving a motor vehicle characterized in that it comprises the following steps:
storing, as a function of time, data relating to the battery during certain phases of use of the motor vehicle;
transmitting the battery-related data stored in a memory of a central server during a battery charging phase in a battery-management station.

The battery-related data may comprise the temperature and the state of charge of the battery and an identifier of the battery and/or of the supplier of each battery and/or the location of the battery.

The method for managing a battery may comprise the following steps:
storing over time the temperature and the state of charge of the battery during a running phase of the motor vehicle,
storing over time the temperature and the state of charge of the battery when the motor vehicle is parked,
storing over time data representing the history of the charging phases of the battery.

The battery-management method may comprise a periodic activation of the motor vehicle when parked in order to carry out the storing of the temperature and the state of charge of its battery.

The battery-management method may comprise a phase of charging the battery in the battery-management station and the transmission of the stored data relating to the battery during this charging phase.

The battery-management method may comprise a step of removing the battery from the motor vehicle in the battery replacement station, then connecting it to a battery charger, battery-related data being transmitted from a memory associated with the battery via the charger.

The battery-management method comprises a first step of transmitting the stored data relating to the battery to a supervision unit of the battery-management station and a second step of transmitting these data from the supervision unit of the management station to the memory of the central server.

The invention also relates to a method for managing a stock of batteries for driving motor vehicles, characterized in that it uses the method for managing each battery of the stock as described above.

The invention also relates to a data-recording medium that can be read by a computer on which is recorded a computer program comprising computer-program code means for implementing the steps of the method as described above.

The invention also relates to a device for managing a battery for driving a motor vehicle, characterized in that it comprises a means of connection to a memory comprising data relating to the battery of a motor vehicle, a means of transmitting data to the memory of a central server and a means of implementing a method for managing a battery as described above.

The means for transmitting data to the memory of a central server may comprise at least one fieldbus for a first transmission to a supervision unit of a battery-management station, then a digital network of the internet type for a second transmission to the memory of the central server.

The battery-management device may comprise several battery chargers associated with a fieldbus of the CAN bus type for a transmission of data from a memory associated with a battery to a battery charger, and a link by fieldbus from each charger to a supervision unit of a management station.

These objects, features and advantages of the present invention will be explained in detail in the following description of a particular embodiment made in a nonlimiting way with respect to the attached figures in which:

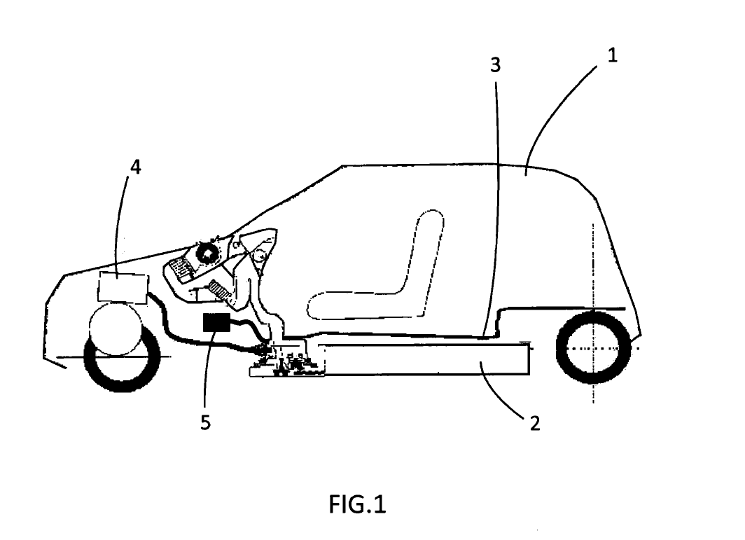

FIG. 1 represents a motor vehicle according to one embodiment of the invention.

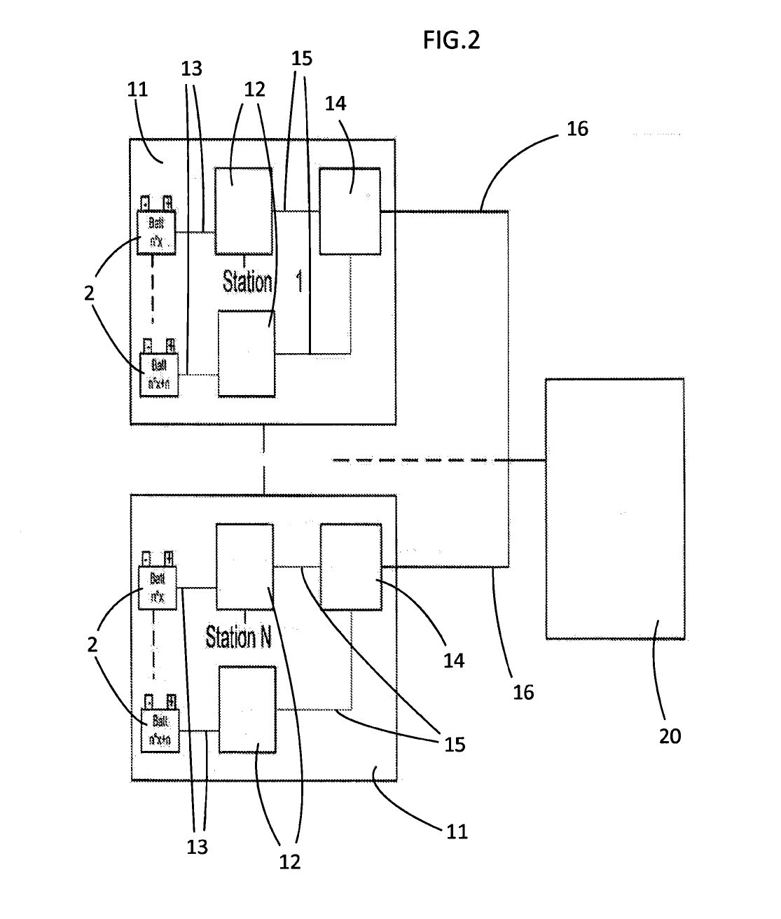

FIG. 2 represents a battery-management device according to one embodiment of the invention.

The concept of the invention is based first of all on a storing of certain data relating to the battery, pertinent to its performance, in a real situation, that is to say during any real use of the motor vehicle, for example in an operating phase of the vehicle, in a parking phase, and/or during a charging of the battery, in order to allow learning and diagnosis of its operation. Then, this storing of data is used by its regular transmission to a central server which carries out an intelligent processing of these data and then makes it possible to establish, for example, a diagnosis of the state and the performance of a certain battery, detect any faults it may have, improve and optimize its operation, etc. For this reason, the invention is finally based on a method and a device for managing a battery for driving a motor vehicle, of which a particular embodiment will now be described.

FIG. 1 represents a motor vehicle 1 fitted with a battery 2 removably attached beneath its floor 3 and connected to an electrical driving means 4 of the traction type. As a variant, the battery 2 could be attached in a different housing on the motor vehicle.

The motor vehicle 1 is also fitted with a computer 5 and with at least one memory, not shown, connected to the battery 2, and more precisely to one or more sensors for measuring data pertinent to the operation of the battery. Moreover, the computer is advantageously connected to the central computer of the motor vehicle, not shown, in order to associate the stored, battery-related data with certain more general operating conditions of the motor vehicle. In order to carry out these storage operations, the motor vehicle is fitted with any software and/or hardware means for implementing the steps of the method that will be described in detail below.

Thus, the battery-management method comprises a first step of storing related data relating to the battery.

Depending on how the battery is used, during a running phase of the motor vehicle, the temperature and the state of charge of the battery are stored over time. These two items of information particularly make it possible to understand the aging of the battery. For this, the battery is fitted with a temperature sensor and comprises a means for measuring its state of charge continuously.

Similarly, when the motor vehicle is parked, the same data are stored as a function of time. For this, the functions of the motor vehicle that are necessary for this storage, that are on standby when the motor vehicle is parked, are activated periodically.

Finally, the data representing the history of the chargings of the battery are similarly stored.

Naturally, the above data are cited as a nonlimiting example; the concept of the invention may be applied to any measurement or estimate of any item of data considered to be pertinent to the operation of a battery for driving a motor vehicle. Moreover, other invariable data such as an identifier of the battery, and/or an identifier of the manufacturer or of the supplier of the battery may also be found in this memory or another memory associated with the battery.

The invention applies to a stock of batteries for driving motor vehicles. Specifically, the storing of data relating to a battery, carried out on each motor vehicle during its use in a real situation, allows optimized learning and operation on a stock of batteries in order to obtain a considerable number of data on which intelligent processes can be carried out.

This is why these various data stored for each battery of the battery stock are combined in one and the same memory, for example that of a central server, in order to form an easily usable database. The battery-management method therefore comprises a second step of transmitting the stored data relating to each battery of the stock to a memory of a central server. According to the embodiment of the invention, provision is made for the batteries of each vehicle to be removable, notably to allow them to be rapidly and easily exchanged in a battery-management station. Specifically, when the battery is discharged, the driver stops in such a station and his empty battery is exchanged against a full battery, according to a process similar to a stop in a service station to fill a fuel tank. As a variant, such a battery could be not replaced but simply recharged. For an optimal use of the battery-related data stored during the use of the motor vehicle, it is of value that these data are transmitted regularly and rapidly to the central server. In order to achieve this objective, the invention proposes, during the stopping phases of the motor vehicles in the battery-management stations, to combine the recharging of the batteries with the transmission of the battery-related data stored during the use of the motor vehicle.

FIG. 2 illustrates an embodiment of the invention according to such an approach. Several battery-management stations 11 therefore receive batteries 2 which are removed from the motor vehicles and placed in recharging phase, via a connection with a battery charger 12.

Each battery-management station comprises several battery chargers 12. According to the embodiment of the invention, each charger 12 is connected to a battery via a CAN bus 13, or even any fieldbus, allowing the transmission of the battery-related data stored during the real use of the motor vehicle. Then, each charger 12 of one and the same battery-management station is connected to a supervision unit 14 of the station, which receives these various battery-related data via the chargers 12, through another fieldbus 15. Finally, each supervision unit 14 of each battery-management station 11 is connected to a central server 20 via a digital network 16 which may be the internet.

Therefore, when the charge of the battery of a motor vehicle is insufficient, the vehicle stops at a battery-management station 11. Its empty battery is removed in order to be connected to a charger 12. During its recharging phase, the battery-related data stored during the use of the vehicle are transmitted via the charger 12 to the supervision unit 14 of the battery-management station. For this, the data are in a memory mounted on the removable battery unit of the motor vehicle. As a comment, during this recharging phase, new data representing the method for recharging the battery 2 are stored in the memory associated with the battery. Then, this supervision unit 14 transmits these data to a central server 20 of an operating center. This second transmission is carried out periodically, for example daily at off-peak periods.

This embodiment has the advantage of combining the data-transmission operation with the rapid battery recharging phase, which prevents adding an additional operation to be carried out separately. It also has the advantage of ensuring a regular and frequent upload of the data in order to ascertain the state of the battery sufficiently. Finally, it similarly ensures the rapid and reliable transmission of the data to the operating center. As a comment, this method makes it possible, over time, to fulfil a function of locating the battery within a battery-management station. For this, the transmission to the central server 20 also includes an identifier of the originating station, the location of which is known to the operating center.

Naturally, the invention is not limited to the structure described above. The data-transmission means may be different from those mentioned and the transmission to the central server 20 may use another circuit than via the charger 12 and/or the supervision unit 14. The transmission of the data from a battery-management station to the central server may be carried out by any remote-communication means.

Moreover, the same principle could be used with the aid of batteries that are irremovably attached to a motor vehicle, the memory comprising the battery-related data then being able to be in any zone of the motor vehicle and associated with a means of connection to the outside for the transmission of these data by a communication means with or without contact.

The central server thus knows with great accuracy, almost in real time, the state of all the batteries of the stock of batteries and their location. Moreover, it can carry out statistical calculations, averages for example, on the data transmitted by all the battery-management stations of the stock in order to deduce therefrom certain operating rules, and analysis of its aging, of its faults etc. It can thus generate an aging model of the batteries as a function of the transmitted parameters such as the temperature, etc. These items of information, aging models, etc. are then transmitted to the various motor-vehicle battery-management stations which use them to establish diagnostics on a given battery.

The invention also relates to a medium comprising a computer program allowing the implementation of all or some of the methods explained above, at the motor-vehicle battery-management station and/or in a central server of an operating center.

1-10. (canceled)

11. A method for managing a battery for driving a motor vehicle, comprising:
storing, as a function of time, data relating to the battery during certain phases of use of the motor vehicle, the data comprising a temperature and a state of charge of the battery and an identifier of the battery and/or of a supplier of each battery and/or a location of the battery;
transmitting the battery-related data stored in a memory of a central server during a battery charging phase in a battery-management station;
storing over time the temperature and the state of charge of the battery during a running phase of the motor vehicle;
storing over time the temperature and the state of charge of the battery when the motor vehicle is parked; and
storing over time data representing a history of charging phases of the battery.

12. The method for managing a battery as claimed in claim 11, further comprising a periodic activation of the motor vehicle when parked to carry out the storing of the temperature and the state of charge of its battery.

13. The method for managing a battery as claimed in claim 10, further comprising a phase of charging the battery in the battery-management station and transmission of the stored data relating to the battery during this charging phase.

14. The method for managing a battery as claimed in claim 13, further comprising removing the battery from the motor vehicle in a battery replacement station, then connecting the battery to a battery charger, battery-related data being transmitted from a memory associated with the battery via the charger.

15. The method for managing a battery as claimed in claim 13, further comprising transmitting the stored data relating to the battery to a supervision unit of the battery-management station and transmitting the data from the supervision unit of the management station to the memory of the central server.

16. A method for managing a stock of batteries for driving motor vehicles, using the method for managing each battery of the stock as claimed in claim 11.

17. A non-transitory data-recording medium that can be read by a computer on which is recorded a computer program comprising computer-program code means for implementing the method as claimed in claim 11.

18. A device for managing a battery for driving a motor vehicle, comprising:
a means of connection to a memory comprising data relating to the battery of a motor vehicle;
a means of transmitting data to the memory of a central server; and
a means of implementing a method for managing a battery as claimed in claim 11.

19. The device for managing a battery as claimed in claim 17, wherein the means for transmitting data to the memory of a central server comprises at least one fieldbus for a first transmission to a supervision unit of a battery-management station, then a digital network of internet type for a second transmission to the memory of the central server.

20. The device for managing a battery as claimed in claim 18, comprising plural battery chargers associated with a fieldbus of the CAN bus type for a transmission of data from a memory associated with a battery to a battery charger, and a link by fieldbus from each charger to a supervision unit of a management station.
